(19) United States
(12) Patent Application Publication
(10) Pub. No.: US 2011/0175365 A1
(43) Pub. Date: Jul. 21, 2011

(54) WIND-DRIVEN ELECTRIC GENERATOR STRUCTURE VIBRATION-DEADENING APPARATUS AND METHODS

(76) Inventors: Douglas Hines, Grapevine, TX (US); James E. Ingle, Ellettsville, IN (US)

(21) Appl. No.: 13/008,225

(22) Filed: Jan. 18, 2011

Related U.S. Application Data
(60) Provisional application No. 61/295,392, filed on Jan. 15, 2010.

(51) Int. Cl. F03D 11/04

(52) U.S. Cl. 290/55

(57) ABSTRACT

The disclosure includes methods and apparatus for deadening the effects of vibrations in wind-driven electric generator supporting structures, and improving the ability of structures supporting wind-driven electric generators to operate in the presence of vibration-creating conditions. One or more various vibration-deadening structural element interconnecting or coupling apparatus can be included in the supporting structure for wind-driven generators for deadening the transmission of vibration between the structural elements to which they are connected.

### CLAIM OF PRIORITY

This patent application claims the benefit and filing date of U.S. Provisional Patent Application No. 61/295,392, filed Jan. 15, 2010.

### FIELD OF THE INVENTION

The inventions of the patent application relate to wind-driven electric generator methods and apparatus, including land-based and off-shore wind-driven electric generator structures, and provide methods and apparatus that provide reliable support and service life for wind-powered electric generators, whether land-based or offshore.

### BACKGROUND

There is an increasing need for electric energy, particularly for electric power generation without the use of fossil fuels and the generation of pollution of the environment or atmosphere. This need has led to the development of land-based, wind-driven electric generators and their use in “wind farms,” in which multiple wind-driven electric generators are grouped together in windy locations, such as mountain passes of Southern California, for generation of electric power for consumption. Such wind farms have been used in foreign offshore locations, but such locations have been generally limited by the technology available at the time to shallow water, i.e., where the water is less than 50 feet deep. Such shallow water locations are close to the shoreline, where the wind-driven generators and their supporting structures can be seen, and where public reaction in the United States opposes their installation. In addition, these prior offshore installations have required the construction of a stable foundation in the sea floor to reliably support each wind-driven electric generator and its supporting structure, which are generally monopole or tripods, at a sufficient height above the water surface to prevent damage to the wind-driven generator and its driving propellers by sea water and wave action, and to expose its propellers to wind. The construction of such supports up to 50 feet below the water surface is extremely expensive and is damaging to the sea environment.

U.S. Pat. No. 7,163,355, the disclosure of which is incorporated herein by reference, presents a solution to these limitations to the offshore use of wind-driven generators. The methods and apparatus disclosed in U.S. Pat. No. 7,163,335 (hereafter the '355 patent) are self-installing without damage to sea floor, and are not limited to shallow waters, but permit one or multiple electric generators to be located and installed in offshore locations with water depths up to 600 feet, well out-of-sight from the shore. Furthermore, the methods and apparatus of the '355 patent are substantially less expensive to manufacture and install, and can be relocated from one location to another location to take advantage of more favorable winds, or to permit additional wind-driven generators to be added to a wind farm.

In both land-based and offshore locations, the supporting structures for the wind-driven generators are exposed to influences that can create or induce dangerous vibrations in the supporting structure. If such vibrations include the natural frequency of vibration of the supporting structure of a wind-driven generator, the supporting structure may become damaged or fail, possibly requiring shut down of the electric generator and repair or rebuilding of its support. Such influences include vibrational energy created by the rotating parts of the wind-driven electric generator that include imbalances in the rotating parts of the electric generator, and its wind-driven blades. Such influences can also include variations in air pressure and in air currents created by the wind-driven blades as they rotate past the supporting structure and act on the surfaces of the supporting structure and blades and, through the blades, on the rotating parts of the wind-driven electric generator. In offshore locations of wind-driven generators, waves and water currents can also act on the supporting structure and create vibrations that can contribute to dangerous vibrations in the supporting structures for a wind-driven generator.

In the past, vibration resistance was imparted to such supporting structures by “brute force” that is, by increasing their structural rigidity, for example, or by increasing the thicknesses of the materials comprising the supporting structure. For example, where a monopole was used as support for the wind-driven generator, the thickness of the steel in the monopole was increased several inches or more than the thickness needed for support of the wind-driven electric generator and its blades to stiffen the support and resist its vibratory movements. The resulting heavy steel structures were themselves excessively costly and imposed additional weight-supporting requirements on their foundations in an effort to provide adequate fatigue service life and reduce the risk of damage from vibration.

### BRIEF SUMMARY OF THE DISCLOSED INVENTIONS

The inventions of the disclosure include methods and apparatus for deadening the effects of vibrations in wind-driven electric generator supporting structures, and improving the ability of structures supporting wind-driven electric generators to operate in the presence of vibration-creating conditions. In the invention, one or more vibration-deadening structural element interconnecting or coupling apparatus can be included in the supporting structure for wind-driven generators. Such vibration-deadening couplers interconnect structural elements of wind-driven electric generator structures while deadening the transmission of vibration between the structural elements to which they are connected. Such vibration-deadening couplers and interconnectors can take various forms, but generally include deformation-free connection elements for adjacent structural elements of the wind-driven generator supporting structure and an intermediate vibration deadening element or structure that can comprise an elastomeric material, a composite including elastomers, or an elastomer/spring composite, such vibration-deadening elements absorbing energy represented by the vibrational movement between the deformation-free interconnection elements, thereby inhibiting its transfer from one connection element to the other and deadening the effect of any vibrations.

In the invention, at least one vibration-deadening interconnection is preferably included below the wind-driven electrical generator assembly, herein referred to as the “nacelle”. In a preferred multi-legged supporting structure for one or more wind-driven electric generators, such those disclosed in the '355 patent, it is preferred to include vibration-deadening elements in each leg of the multi-legged support, preferably between each leg and the supporting platform, or platforms, for the one or more wind-driven electric generators. The inclusion of vibration-deadening elements in the supporting structures for wind-driven electric generators can permit reduction of the size of the structure and the materials used to support wind-driven electric generators, and it may be advantageous to include more than one vibration-deadening interconnection between vibration sensitive parts of a wind-driven generator support, whether earth carried or offshore.

### BRIEF DESCRIPTION OF THE DRAWINGS

FIGS. 1 and 2 are orthogonal views of a land-based wind-driven electric generator supporting structure including the invention.

FIGS. 3 and 4 are orthogonal views from above and from one side of an offshore wind-driven electric generator and its supporting structure including the invention.

FIG. 5 is a perspective view of a plurality of wind-driven electric generators carried by an offshore platform and including the invention.

FIG. 6 is a diagrammatic illustration of a vibration-deadening structural element interconnector of the invention and its parts; and

FIGS. 7-14 illustrate various vibration-deadening structural interconnectors or couplings.

### MORE DETAILED DESCRIPTION OF THE INVENTION

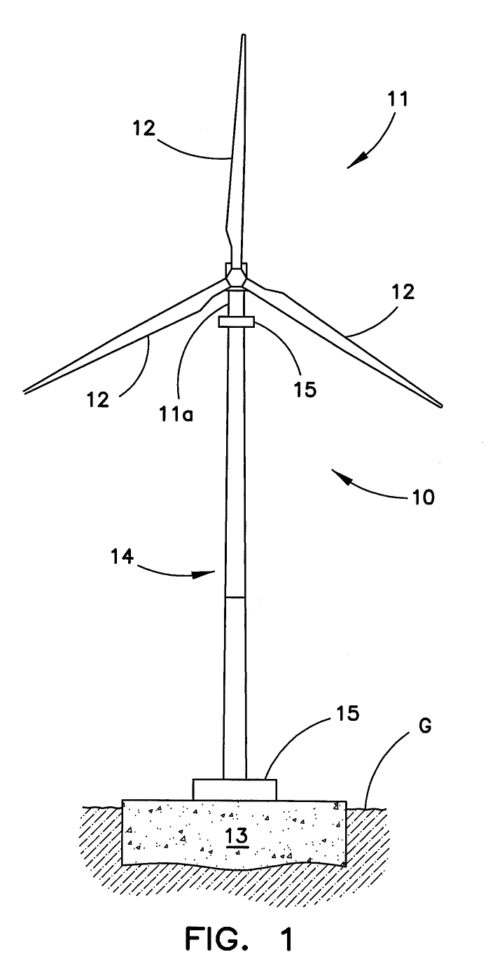

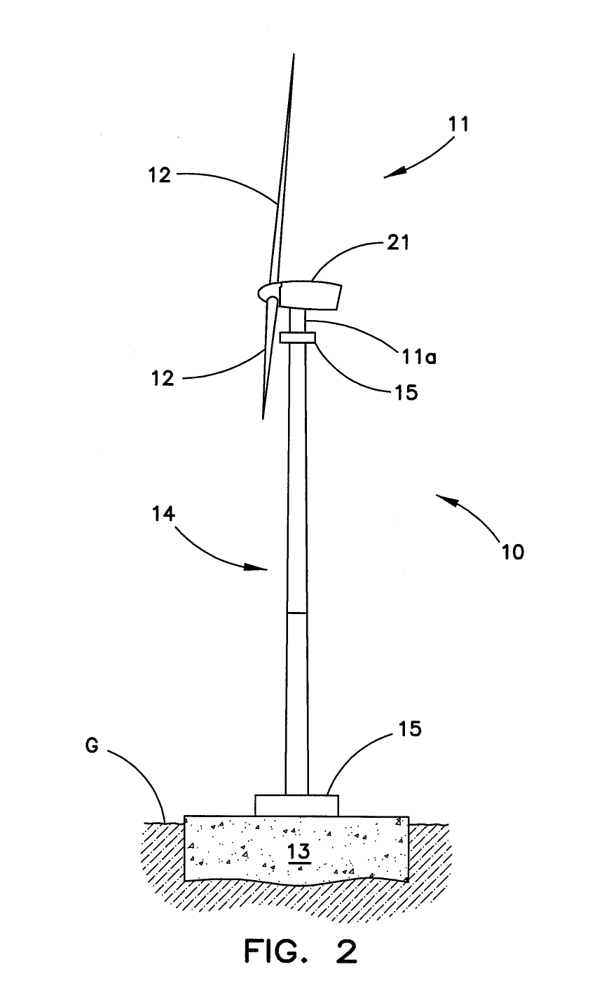

FIGS. 1 and 2 are orthogonal views of a land-based, wind-driven electric generator structure 10. The wind-driven electric generator structure 10 includes a nacelle portion 11, which includes an electric generator driven by a plurality of blades 12, which are rotated by wind. As shown in FIGS. 1 and 2, the nacelle 11 is supported above the earth by a foundation 13 formed in the earth and a monopole structure 14.

In operation, the blades and the electric generator are driven in rotation by the wind. Any lack of balance in the rotating parts of the nacelle portion 11 can generate a vibration of the nacelle 11 that is imposed on the monopole structure 14. In addition to vibrations that are caused by lack of balance of the rotating parts of the nacelle 11, vibrations are imposed on the blades 12 of the nacelle as a result of the interaction of the blades 12, the portions of the supporting structure 14 that they rotate past, and the adjacent atmosphere. As the blades 12 sense their passage past the adjacent portion of the supporting structure 14, they experience a reactive force that is transmitted through the blades 12, the shaft and shaft bearings on which they rotate, the stationary portion of the nacelle 11, and ultimately the monopole structure 14. Because the blades 12 are driven by winds of varying velocity, the vibrations that the wind-driven electric generator structure 10 are exposed to can be of varying frequency and can include one of the natural frequencies of vibration of the monopole supporting structure 14 (or other supporting structure), which may generate stress-creating vibrations that can damage the monopole structure.

In the past, supporting structures for wind-driven generators were designed to include sufficient materials to increase the material in the supporting structure to substantially increase its rigidity and decrease its vibratory motion and the material stresses to which the supporting structure was imposed.

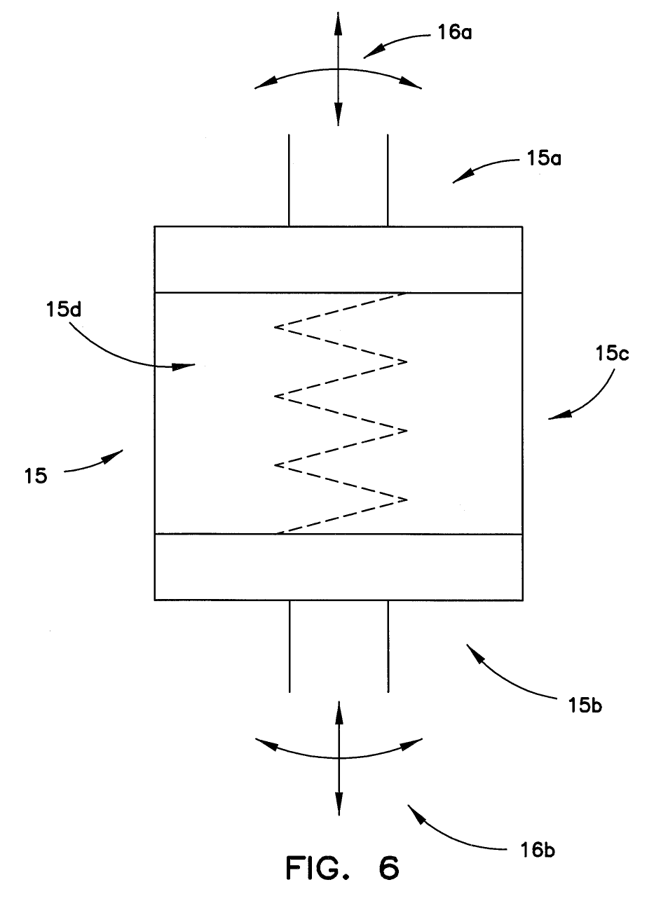

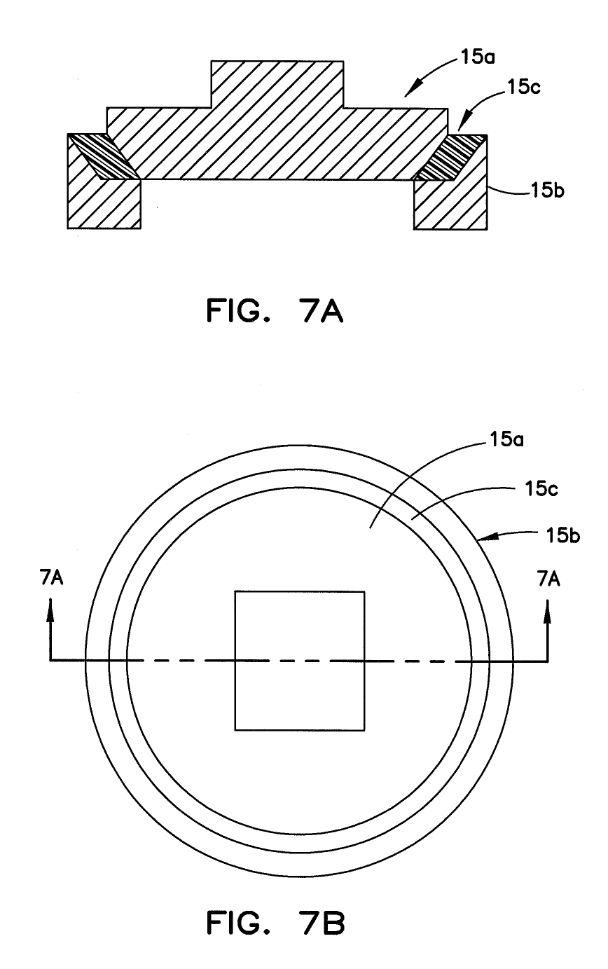

As illustrated in FIGS. 1 and 2, in the invention one or more vibration-deadening element interconnectors 15 are included in the wind-driven electric generator supporting structure 10. The vibration-deadening basis of the interconnectors 15 is illustrated by the diagram of FIG. 6, and includes first and second substantially rigid connection elements 15a, 15b connected with a vibration-deadening element 15c. For example, the upper element 15a is rigidly connected to a support 11a for the nacelle 11 for its support and may be exposed to the vibrations indicated by the arrows 16a, and the lower element 15b may be rigidly connected to the monopole supporting structure 14. Because the interconnecting element 15 includes a central vibration-deadening portion 15c, the vibration to which the monopole structure 14 is exposed can be substantially reduced in energy and magnitude, as indicated by the arrows 16b. The central vibration-deadening portion 15c of the interconnector 15 may include one or more elastic materials, including elastomeric compounds and materials and spring-like metallic elements as diagrammatically illustrated by 15d. FIGS. 7-14 illustrate a number of possible arrangements for vibration-deadening interconnectors.

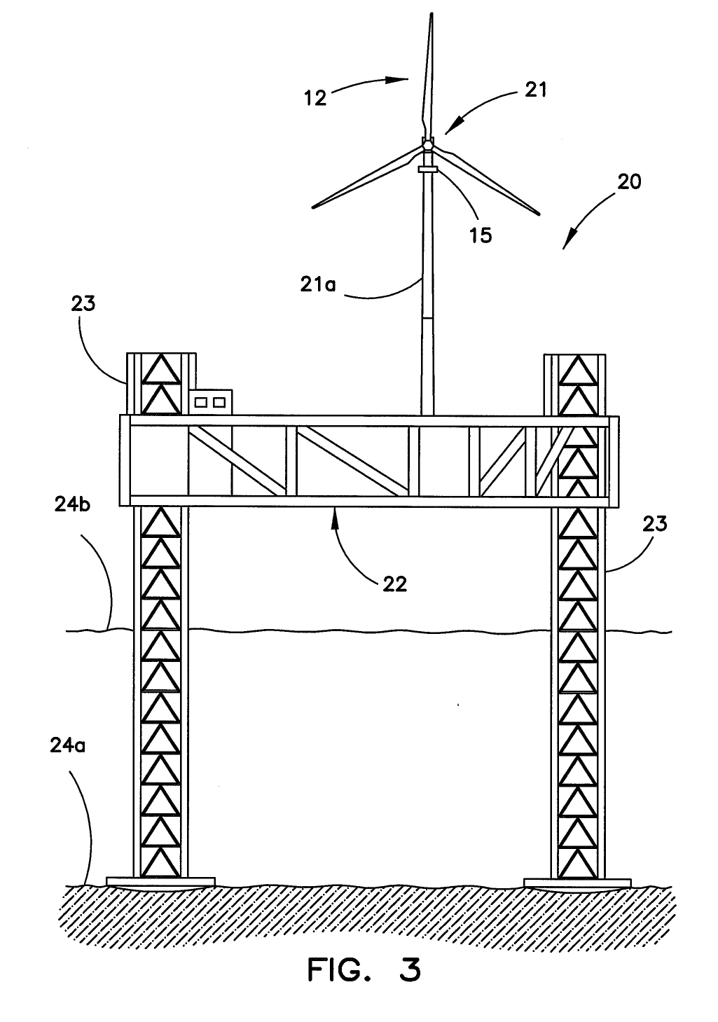

FIGS. 3-5 illustrate offshore wind-driven generating stations, as described in the '355 patents, and including the invention. As illustrated in FIGS. 3-5, one or more wind-driven electric generators can be carried in an integrated relocatable offshore platform 20, 29. As indicated in FIGS. 3-5, wind-driven electric generators may be supported by the supporting legs 23 of the offshore platform 20, 29, which can carry more than one wind-driven electric generator 21, at an adjustable height above the water surface. The offshore platform 20, 29 preferably includes a buoyant platform structure 22, permitting the offshore platform 20, 29 and the electric generators 21 to be towed to a chosen location with the supporting legs 23 extending above the buoyant platform structure 22. At the chosen location the supporting legs 23 are lowered into the sea until they engage the sea floor and lift the buoyant platform structure 22 above the water surface to a reliable operating height for the wind-driven generators 21. Relocation of the wind-driven electric generators 21 can be effected by raising the supporting legs 23 from their engagement with the sea floor to above the buoyant platform structure 22 and towing the offshore platform 20, 29 to a new chosen location. As indicated in the '355 patent, no pre-installation preparation of the sea floor is required for relocation and operation of the offshore electric generators, and no corrective treatment of the sea floor is needed at the former location of the offshore platform 20, 29.

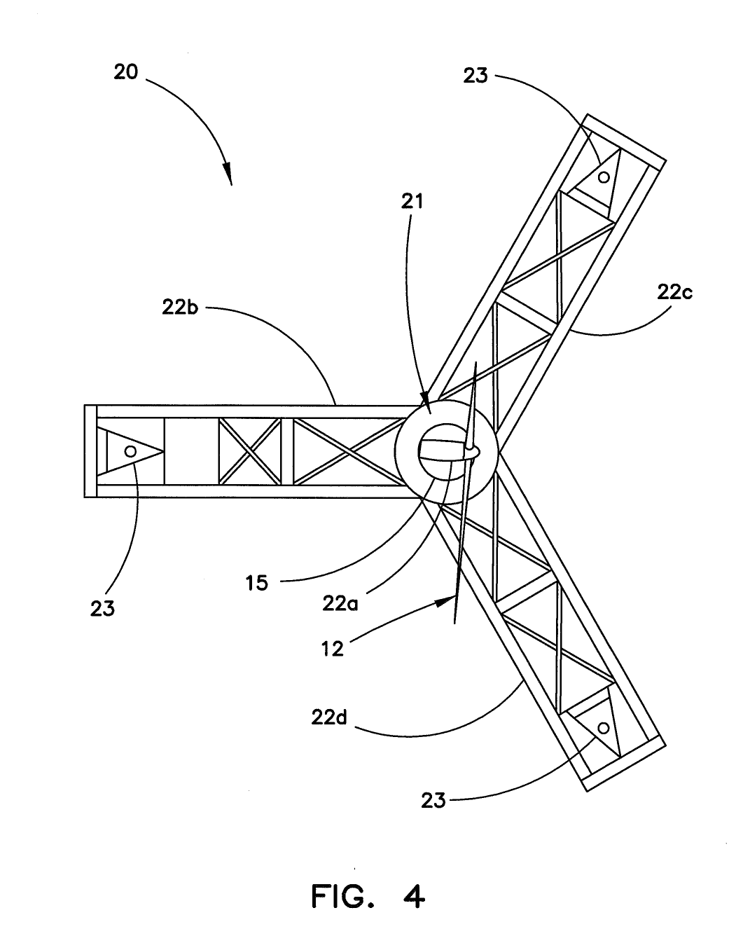

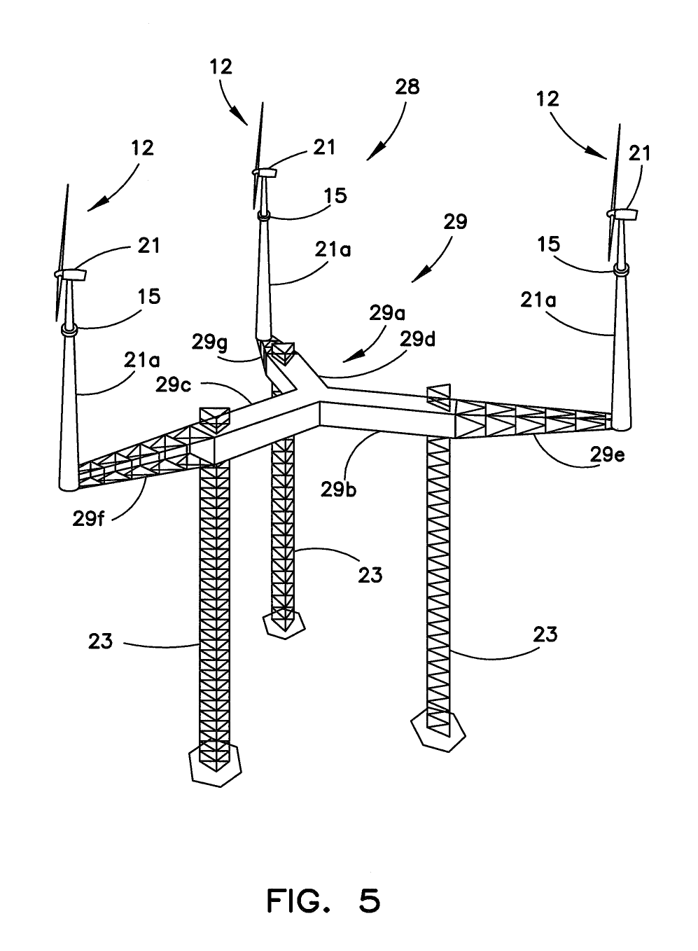

As illustrated in FIGS. 3-5, a vibration-deadening interconnection 15 is associated with each wind-driven electric generator 21 and can be included in the supporting structure between the wind-driven electric generator nacelle 21 and its support 21a from the platform structure 22, 29. FIGS. 3 and 4 illustrate a single wind-driven electric generator 21 supported by a platform 22 carried by three supporting legs 23, which engage the sea floor 24a and carry the wind-driven electric generator 21 above the surface 24b of the sea. In the apparatus of FIGS. 3 and 4, a vibration-deadening interconnector 15 is included in its supporting structure above the platform 22 and preferably adjacent to the possibly vibration-generating wind-driven electric generator 21. FIG. 5 illustrates three wind-driven electric generators 21 supported by a single platform 29, which is carried by three supporting legs 23 which can engage the sea floor and left the platform 29 and its three wind-driven electric generators 21 above the surface of the sea (in the manner shown in FIGS. 3 and 4). In such multi-legged supporting structures, it may be preferable to provide vibration-deadening interconnections between each of the supporting legs 23 and the platforms 29 for the wind-driven electric generators.

Although it may be possible with the offshore wind-driven electric generating stations disclosed by the '355 patent, to raise and lower the wind-driven electric generators 21 to change their rate of rotation and the vibration frequency they may generate, and also to change the natural vibration frequency of the supporting platform 20, 29 and its supporting legs 23, this possibility is not consistent with the greater need to rigidly fix the platform 20, 29 to the legs 23 while the offshore platform 20, 29 is on station and in operation.

FIGS. 7-14 illustrate various embodiments of vibration-deadening interconnections that may be used in the invention. In FIGS. 7-14, the illustrated elements of the vibration-deadening interconnections are indicated with the same element numbers 15a, 15b, 15c, and 15d as the corresponding elements in the diagrammatic illustration FIG. 6.

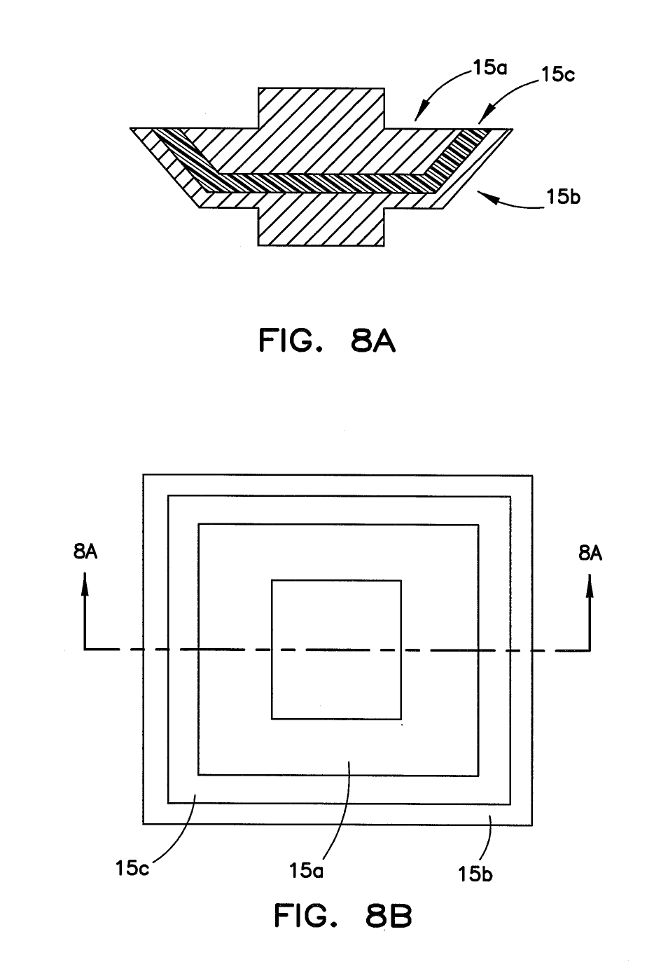

FIGS. 7A, 7B, 8A and 8B illustrate two possible vibration-deadening interconnectors for wind-driven electric generator systems. In FIGS. 7A, 7B, 8A, and 8B the elements of the illustrated interconnectors 15 have been given the element numbers of the corresponding element of the diagrammatic FIG. 6.

FIG. 7A is a cross-sectional view of interconnector 15, taken at a vertical central plane through line 7A-7A of FIG. 7B, which is a view from above the FIG. 7A interconnection 15. In the interconnection of FIGS. 7A, 7B, the interfacing surfaces of its elements 15a, 15b, 15c have segmented spherical surfaces wherein the first interconnecting element 15a has an outwardly-facing shape as a spherical segment, nested within the vibration-deadening element 15c, which has an inner surface with an inwardly-facing shape as a spherical segment of a sphere having the same radius as the outwardly-facing spherical segment of the connecting element 15a. The vibration-deadening element 15c has an outer surface with an outwardly-facing shape as a spherical segment, which, in turn, is nested within element 15b, which preferably has an inner surface with an inwardly-facing shape as a spherical segment having the same radius as the outwardly-facing spherical segment surface of element 15c. With the interconnector 15 illustrated by FIGS. 7A, 7B, the first interconnection element 15a and vibration-deadening element 15b are carried within the second interconnection element 15b and by the support 21a for the wind-driven electric generator assembly, as shown in FIGS. 1-5.

FIG. 8A is a cross-sectional view of another interconnector 15 taken at a vertical central plane through the line 8A-8A of FIG. 8B, which is a view from above the FIG. 8A of interconnection 15. In the interconnection of FIGS. 8A, 8B, the interfacing surfaces of elements 15a, 15b, 15c have peripheral surfaces that are angled upwardly so that the first interconnection element 15a is nested within the vibration-deadening element 15c and the second interconnecting element 15b.

In the vibration-deadening interconnectors of FIGS. 7A, 7B, 8A and 8B, the upwardly-extending interfacing peripheral surfaces of the elements 15a, 15b, and 15c can prevent laterally-extending dislocating movements of the first interconnecting element 15a that can destroy their vertically coaxial relationship while deadening vibrational energy transferred between the first and the second interconnecting elements 15a, 15b.

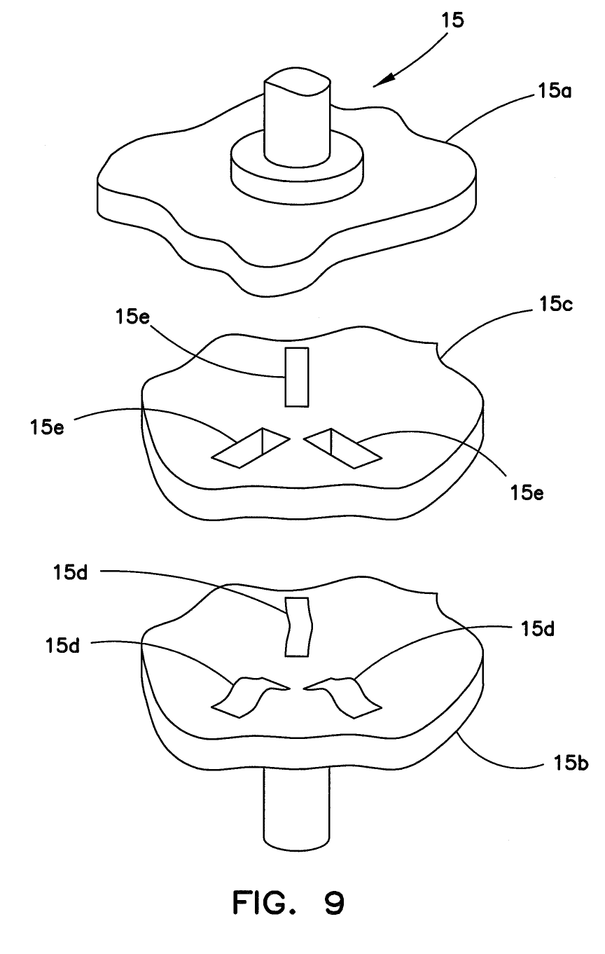

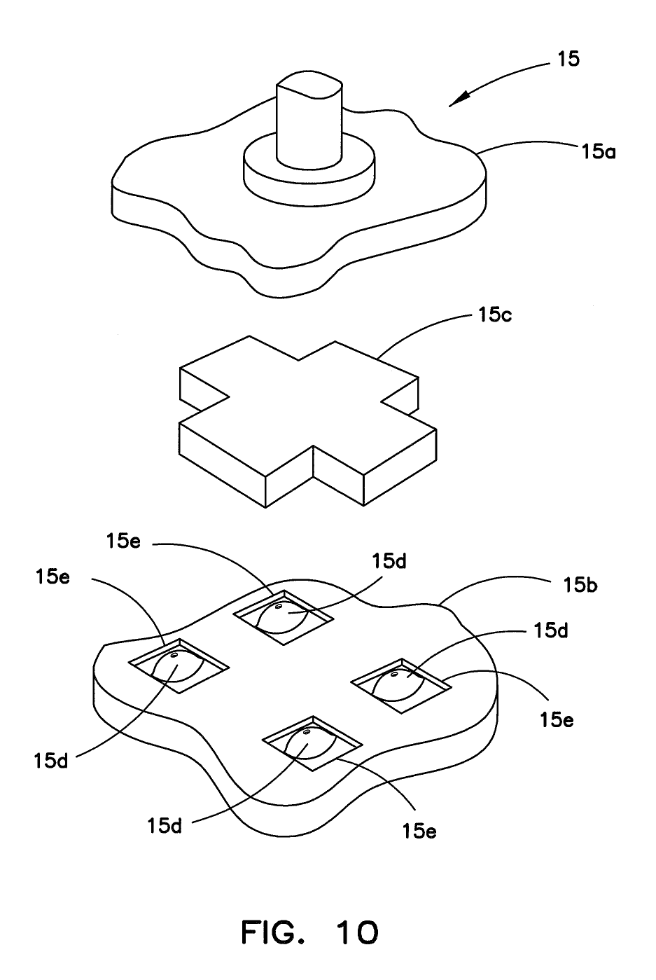

FIGS. 9-11 illustrate the central portions of vibration-deadening interconnectors 15 that include, in addition to a vibration-deadening elastomer element 15c, a metallic spring element 15d. While the outer peripheral portions of the interconnectors 15 of FIGS. 9-11 are not illustrated, it should be understood that at least portions of the peripheries of the three elements 15a, 15b and 15c can project upwardly at their interfaces to resist lateral movements that can destroy the coaxial vertical concentricity of the first and second interconnector elements 15a, 15b. In FIGS. 9-11, the illustrated elements of the interconnectors 15 have been given the element number of the corresponding elements of the FIG. 6 diagram.

As illustrated in FIG. 9, the central portion of the interconnecting element 15b carries a plurality of leaf spring elements 15d spaced and oriented to yield to vibrational movement of the first interconnector element 15a vertically and in any vertical plane about any horizontal axis near the geometric center of the vibration-deadening element 15c. In the FIG. 9 embodiment, the three leaf springs are oriented spoke-like and angled at 120° spacings, and are welded, or otherwise fastened, at one of their ends to the second interconnector element 15b to maintain their relationship while permitting their flexure in response to vibratory movements of the first interconnector element 15a. As shown in FIG. 9, the vibration-deadening element 15c includes cut out portions 15e in which the leaf springs fit upon assembly of the interconnector 15.

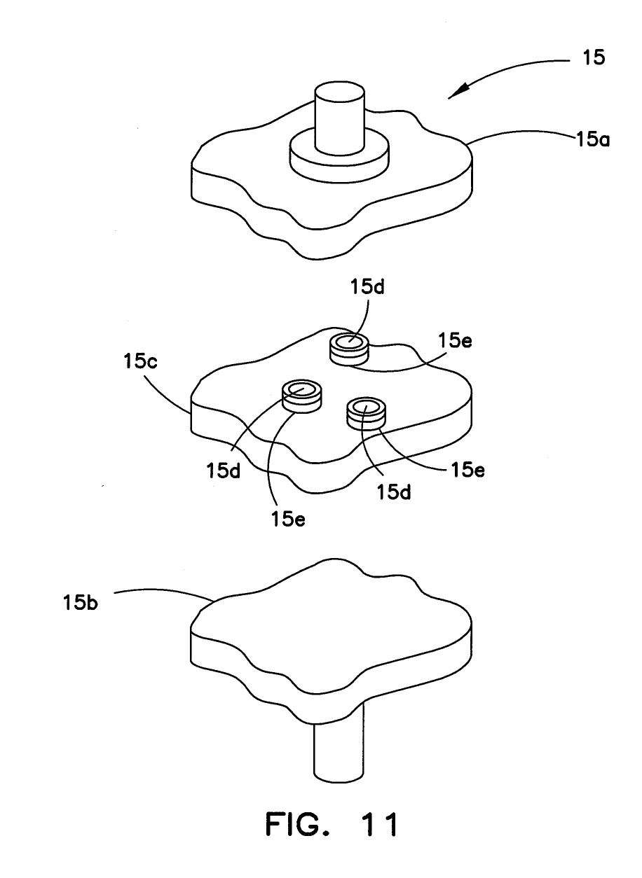

The FIG. 10 interconnector includes four spaced expanded-plate springs uniformly arranged and spaced in a square arrangement and carried by the second interconnector element 15b to yield to vibrational movement vertically and about any horizontal axis near the geometric axis of the vibration-deadening element 15c. The four springs 15d are welded or otherwise fastened to the second interconnector element 15b to maintain their uniform spacing but permit their fixture in response to vibrational movements of the first interconnector element 15a. As illustrated by FIG. 10, the vibration-deadening element 15c includes four peripheral cut out portions 15c to permit an effective interaction between the first and the second interconnector elements 15a, 15b.

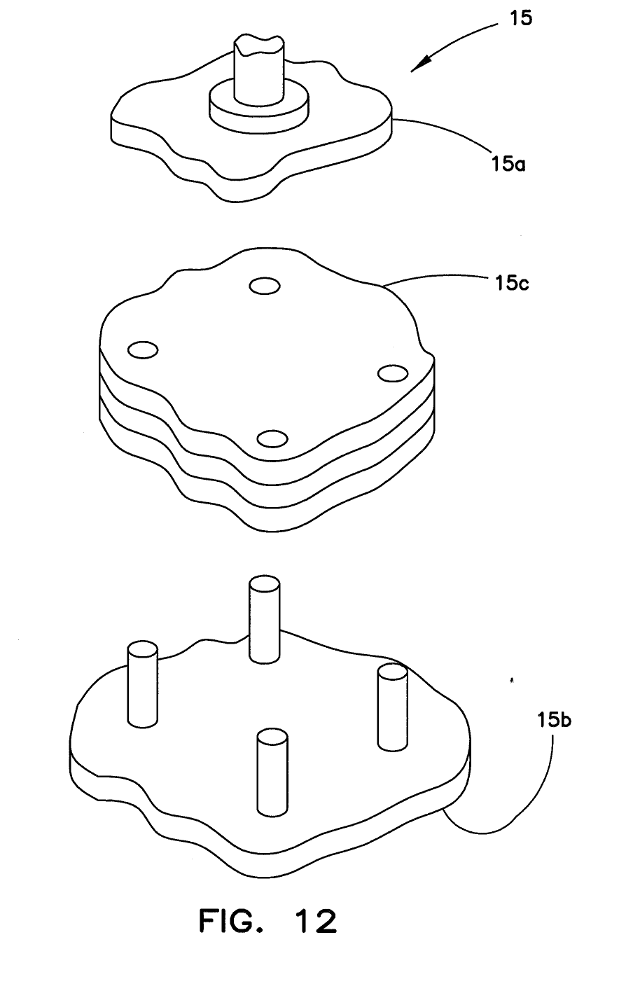

In the FIG. 11 interconnection, the vibration-deadening element 15c includes pockets 15e extending into, and, in some cases entirely through the vibration-deadening element 15c that carry coil springs 15d. The pockets 15e are spaced around the central vertical axis of the interconnection 15 at intervals of 120°. When the interconnection of FIG. 11 is assembled, the first interconnection element 15a is free to vibrate vertically and about any horizontal axis near the geometric center of the vibration-deadening element 15c.

In the interconnectors of FIGS. 9-11, the inclusion of metallic spring elements 15d can be used to react to large vibratory movements while the elastomeric portion 15c can control smaller vibratory movements and can extend the life of the interconnectors 15.

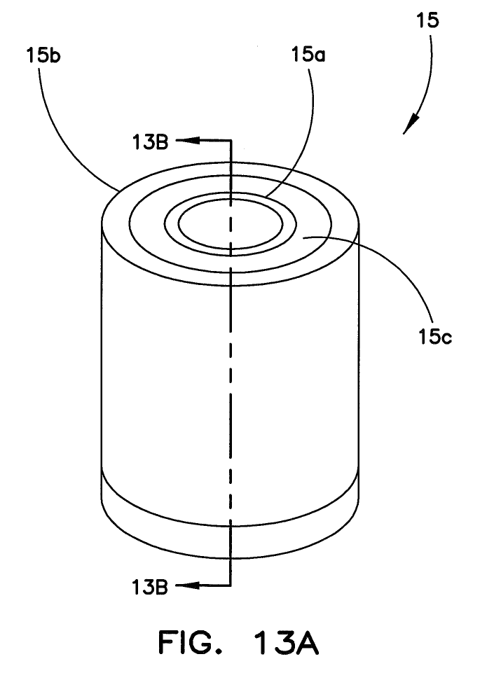

The interconnector 15 of FIG. 12 illustrates that the vibration-deadening element 15c can comprise a plurality of elastomeric materials with different properties advantageously arranged to deaden the transmission of vibration between the first and second interconnectors 15a, 15b. For example, the vibration-deadening element may include upper and lower lagers of a more pliable elastomer to yield to and deaden smaller vibrations and may include at least one central layer of a less pliable elastomer to react to and deaden larger vibratory movements.

The vibration-deadening element 15c may be designed with any number of elastomers having different durometers.

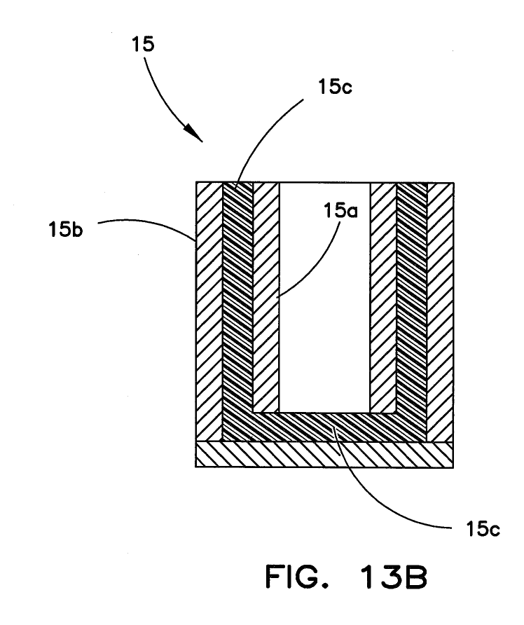

FIGS. 13A and 13B illustrate a vibration-deadening interconnector 15 including tubular first and second interconnector elements 15a, 15b with a cylindrical vibration-deadening element 15c therebetween and beneath the first interconnector element 15a. FIG. 13A is a perspective view of such an interconnector, and FIG. 13B is a cross-sectional view of one side of the interconnector 15 taken at a vertical plane through line 13B-13B showing the arrangement of the first and second interconnector elements 15a, 15b and the vibration-deadening elements 15c. In such vibration-deadening interconnectors, the vibration-deadening element 15c beneath the first interconnecting element 15a must have significant strength in compression. Rather than comprising a cylinder, the vibration-deadening system between the first and the second interconnection elements 15a, 15b can be a series of angularly-spaced, vibration-deadening material strips running vertically parallel to the central vertical axis of the interconnector, or a plurality of vertically-spaced circumferential strips between the first and second interconnection elements.

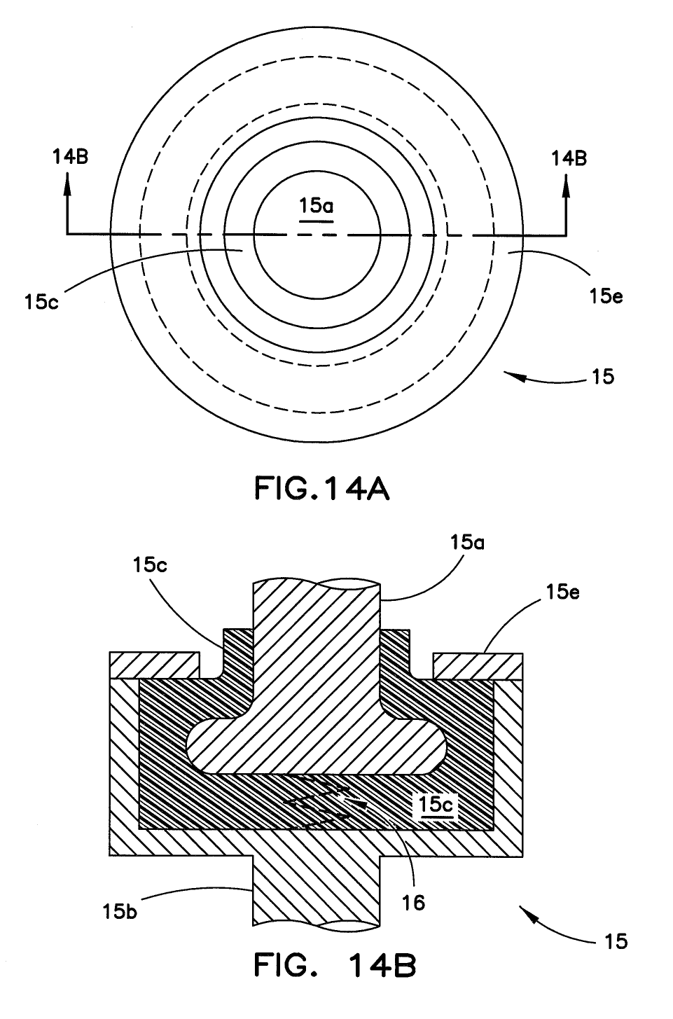

FIGS. 14A and 14B illustrate a vibration-deadening interconnector 15 in which one end of the first connecting element 15a is encapsulated within the vibration-deadening element 15c, which is carried within the second connecting element 15b, which can be partially closed around the first connecting element 15a by a cap 15c fastened to the cup-like lower portion of the second connecting element at its upper edge, thereby capturing the first connecting element 15a within a surrounding volume of the vibration-deadening material of the vibration deadening element 15c. The first connecting element 15a is shaped, e.g. large radius end portions, to reduce stress concentrations in the vibration-deadening material of the vibration-deadening element 15c. It is possible, if advantageous, to include a spring-like element 16 (shown in dashed lines), or a core of substantially more rigid elastomer in the second connecting element 15b under the first connecting element 15a, for improved load-bearing in the interconnection 15.

Those skilled in the art will recognize that in addition to the vibration-deadening interconnector embodiments of the invention illustrated and described herein, there are many more interconnector designs and arrangements that are possible in this invention.

What is claimed is:

1. A vibration-deadening interconnector for a supporting structure for a wind-driven electric generator, comprising
a first interconnector element adapted for connection to a structural element subject to vibration,
a second interconnector element for connection to a structural support for said first interconnector element, and
a vibration-deadening third element connected between the first and second interconnector elements.

2. The vibration-deadening interconnector of claim 1, wherein the vibration-deadening third element is formed elastomer.

3. The vibration-deadening interconnector of claim 1, wherein the vibration-deadening third element is formed from an elastomer with high thermal conductivity, and the interfaces between the vibration-deadening third element and the first and second interconnector elements are adapted for effective heat transfer from the third element to the first and second interconnector elements.

4. The vibration-deadening interconnector of claim 1, wherein the first and second interconnector elements include peripheral portions that resist lateral movements of the first interconnector element in the second interconnector element.

5. The vibration-deadening interconnector of claim 1, wherein the interfacing surfaces of the first, second and third elements of the interconnector comprise the shapes of spherical segments.

6. The vibration-deadening interconnector of claim 2, wherein the third vibration-deadening element comprises one or more metallic spring elements.

7. The vibration-deadening interconnector of claim 1, wherein the vibration-deadening third element comprises an elastomer/fiber composite matrix.

8. The vibration-deadening interconnector of claim 1, wherein the first interconnector element comprises an outer tubular portion, the second interconnector element comprises an inner tubular portion with the third vibration-deadening element between the first and second interconnector elements.

9. The vibration-deadening interconnector of claim 1, wherein the first interconnector element is encapsulated within the vibration-deadening element.

10. A method of supporting a wind-driven electric generator comprising locating at least one vibration-deadening element in the supporting structure for the wind-driven electric generator.

11. The method of claim 9, wherein a vibration-deadening element is located in the supporting structure adjacent the wind-driven electric generator.

12. The method of claim 9, wherein a vibration-deadening element is located between the base of the supporting structure for the wind-driven generator and its underlying earth-based support.

13. The method of claim 9, wherein the supporting structure includes a platform carrying one or more wind-driven electric generators and supported by more than one supporting leg, and a vibration deadening element is located between the platform and each supporting leg.

14. The vibration-deadening interconnector of claim 1, wherein the vibration-deadening third element comprises a plurality of layers of elastomer.

15. The vibration-deadening interconnector of claim 14, further comprising one or more metallic elements between the layers of elastomer.

16. The vibration-deadening interconnector of claim 14, wherein the plurality of layers of elastomer comprises different elastomers in at least two layers.
